(19) United States
(12) Patent Application Publication
(10) Pub. No.: US 2016/0302503 A1
(43) Pub. Date: Oct. 20, 2016

(54) LAYERED MATERIAL WITH RESLIENT RADIANT BARRIER AND METHOD OF MAKING SAME

(71) Applicants: Andrius Birutis, Scottsdale, AZ (US); Sean Daw, Grayslake, IL (US); Sam Landers, Park Ridge, IL (US)

(72) Inventors: Andrius Birutis, Scottsdale, AZ (US); Sean Daw, Grayslake, IL (US); Sam Landers, Park Ridge, IL (US)

(73) Assignee: Alchemi Labs, LLC, Scottsdale, AZ (US)

(21) Appl. No.: 14/949,048

(22) Filed: Nov. 23, 2015

Related U.S. Application Data
(60) Provisional application No. 62/147,471, filed on Apr. 14, 2015.

(51) Int. Cl. A41D 31/00; A42B 1/02; A41B 1/08; B32B 7/12

(52) U.S. Cl. CPC A41D 31/0038; B32B 7/12; A42B 1/02; A41B 1/08; B32B 2305/38; B32B 2437/04; B32B 2437/00; A41B 2500/20

(57) ABSTRACT

A layered material for use as a reflective radiant barrier on objects such as hats, clothing, duffle bags, shade structure canopies, infant carrier canopy, and soft sided coolers. The invention has a planar backing having a back surface and a front surface; a planar radiant barrier material having a back surface and a front surface, the front surface of the planar radiant barrier comprising a reflective radiant barrier, the back surface of the planar radiant barrier material being coupled to the front surface of the planar backing and a mesh material having a plurality of substantially uniform openings, the mesh material disposed on the front surface of the planar radiant barrier material.

### CROSS-REFERENCE TO RELATED APPLICATION

This application claims priority to the following provisional application: U.S. Ser. No. 62/147,471, filed Apr. 14, 2015 entitled: Sun Hats with Radiant Barrier Technology, the contents of which are incorporated herein by reference.

### FIELD OF THE INVENTION

The invention relates to the field of layered materials with radiant barriers for use, inter alia, with clothing, hats, carriers, canopies, windshield sun shades and soft-sided goods.

### BACKGROUND OF THE INVENTION

Many items, including clothing, hats, carriers, canopies, windshield sun shades and soft-sided goods, do not include portions with resilient reflective or radiant barriers. Reflectance of the surface of a material is its effectiveness in reflecting radiant energy. It is the fraction of incident electromagnetic power that is reflected at an interface. The reflectance spectrum or spectral reflectance curve is the plot of the reflectance as a function of wavelength.

What is desired is a material that is layered with a backing, a radiant barrier operable to keep the wearer or user at a temperature that is cooler or warmer than what would otherwise be the case, and a mesh to make the layered material resilient.

### SUMMARY OF THE INVENTION

The invention is a layered material including a radiant barrier for use in combination with, inter alia, clothing, hats, carriers, canopies, windshield sun shades and soft-sided goods. In a basic configuration, the invention's layers comprise a backing material, a radiant, reflective barrier, and a mesh layer with openings optimized to make the layered material resilient, while contemporaneously allowing the maximum exposure of the underlying radiant, reflective barrier to external heat and/or radiation.

### BRIEF DESCRIPTION OF THE DRAWINGS

FIG. 1 is an illustration of the layers comprising a first embodiment of the invention;

FIG. 2 is an illustration of the layers comprising a second embodiment of the invention;

FIG. 3 is a front perspective view illustration of the present invention disposed on a river hat;

FIG. 4 is a front perspective view illustration of the present invention disposed on a Sarah hat;

FIG. 5 is a view of the back of a shirt with the invention disposed thereon;

FIG. 6 is a front view of a shade structure canopy with the invention disposed thereon;

FIG. 7 is a front perspective view of a soft-sided cooler with the invention disposed thereon;

FIG. 8 is flow chart of the steps of the invention; and

FIG. 9 is a side view of two layers of the three layers of the invention.

### DESCRIPTION OF THE INVENTION

All illustrations of the drawings are for the purpose of describing selected versions of the present invention and are not intended to limit the scope of the present invention.

An embodiment of the present invention is a hat made from woven material and a radiant barrier that is exposed to the outside surface and includes ventilation. The radiant barrier material reflects or retains radiant heat from the head of the person wearing the hat, depending on the orientation of the invention. By placing the radiant barrier material where it is exposed to a heat or ultra-violet (UV) source one is able to maximize the object's ability to reflect radiant heat. By placing the radiant barrier material where it is exposed to the surface one is able to maximize the object's ability to reflect radiant heat. The invention can be disposed on a hat that includes side ventilation which further cools the wearer.

A further embodiment of the invention provides for direct exposure to a radiant heat source utilizing a unitary radiant barrier film that has an apparel like quality and may be perforated if required for a specific application. The radiant barrier of the invention reflects radiant heat (infrared heat waves) and blocks substantially all UV rays. In an embodiment, the invention's reflectance has been shown to be effective to reflect up to 80% of infrared heat waves and block over 99.8% of all UV rays. When embodied in a laminated fabric, the radiant barrier takes on an apparel like quality. An open fabric mesh is utilized over the radiant barrier to allow for maximum, direct exposure to the radiant heat source while protecting the radiant barrier from damage.

Further embodiments include articles of clothing, such as a shirt or jersey, a duffle bag, shade structure canopy, baby stroller carriage canopy, or a soft-sided cooler. In such uses, the radiant barrier material is laminated to a thin fabric changing/softening the hand feel of the radiant barrier material and making it suitable for apparel. The radiant barrier is then covered by an open fabric mesh which allows for direct exposure to the radiant heat source while protecting the radiant barrier from damage such as scratching and tearing.

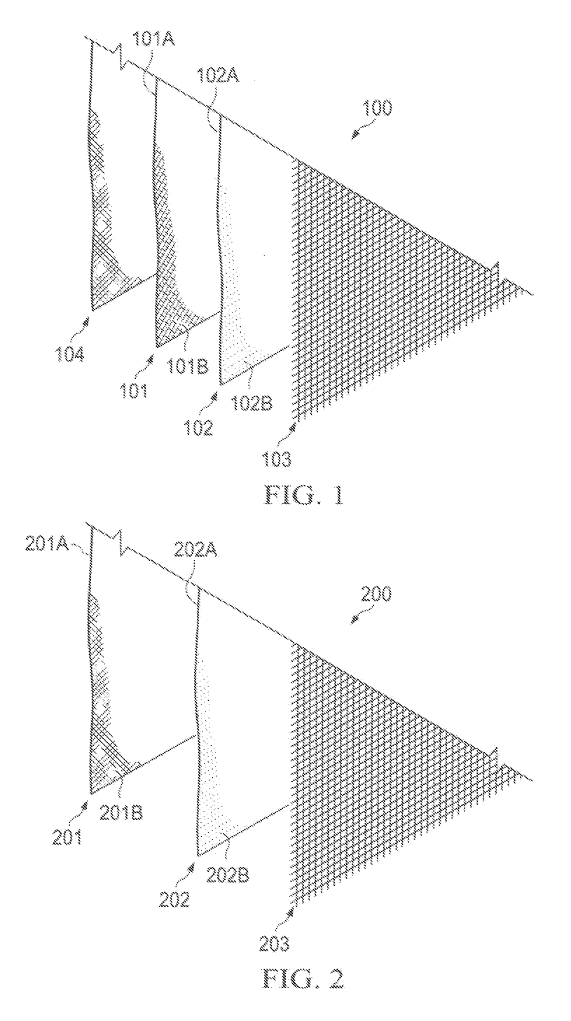

Referring now to the Figures, as seen in FIG. 1, the present invention comprises layered material 100 comprising a planar backing material 101 having a back surface 101A and a front surface 101B, a planar radiant barrier material 102 having a back surface 102A and a front surface 102B, the front surface 102B of the planar radiant barrier material 102 comprising a reflective radiant surface. In an embodiment, the planar radiant barrier material 102 is laminated. The back surface 102A of the planar radiant barrier material is coupled to the front surface 101B of the planar backing material 101 and a mesh material 103 having a plurality of substantially uniform openings is disposed on the front surface 102B of the planar radiant barrier material. The invention is embodied in, integral to, or is disposed upon, a covered object, such covered object as further described herein. In a further embodiment, the invention is the layered material in combination with the covered object.

In an embodiment, the planar backing material 101 comprises a laminated material. In an alternative embodiment, the planar backing material 101 comprises a fabric, textile or woven laminate material, the fabric, textile or laminate material in a further embodiment being coupled or adhered to the object to which the of the planar radiant barrier material 102 is coupled or adhered, such as a hat material 104. In yet a further embodiment, the planar backing material 101 comprises a cardboard material. The planar backing material 101 is preferably between 0.06 mm and 10 mm thick.

The planar radiant barrier material is selected from the group consisting of inter alia, a metallized polyester, an aluminized cloth, a metallized film and a polymer film coated with a thin layer of aluminum or gold.

Referring FIG. 2, the present invention comprises layered material 200 wherein the backing material 201 has a back surface 201A and a front surface 201B, a planar radiant barrier material 202 having a back surface 202A and a front surface 202B, the front surface 202B of the planar radiant barrier material 202 comprising a reflective radiant surface. In an embodiment, the planar radiant barrier material 202 is laminated. The back surface 202A of the planar radiant barrier material is coupled to the front surface 201B of the backing material 201 and a mesh material 203 having a plurality of substantially uniform openings is disposed on the front surface 202B of the planar radiant barrier material.

Reflective radiant barriers include sheets of metalized polyester, aluminized cloth, foils, polymer films coated with a thin layer of aluminum, gold and metallized films. Metallization is performed using a physical vapor deposition process. Aluminum is the most common metal used for deposition, but other metals such as gold, nickel or chromium are also used. The metal is heated and evaporated under vacuum. This condenses on the cold polymer film, which is unwound near the metal vapor source. Polymer films include oriented polypropylene, polyethylene terephthalate (PET), nylon, polyethylene and cast polypropylene. The planar radiant barrier material is preferably between 0.05 mm and 0.25 mm thick.

A mesh is a barrier made of connected strands of fiber, plastic or other flexible/ductile materials. A mesh is similar to a web or a net in that it has many attached or woven strands. A plastic mesh can be made from polypropylene, polyethylene, nylon, PVC or PTFE. Alternatively, the mesh is comprised of a loosely woven or knitted fabric that has a large number of closely spaced openings, apertures or holes.

The invention can be fabricated of any of the foregoing, the size of the openings in the mesh material being optimized to provide resiliency to the layered material while providing sufficient opening size to allowing maximum reflectance. In an embodiment, the mesh material openings are preferably between the sizes of 3 millimeter radius and 9 millimeter radius. In a further embodiment, the mesh material openings are preferably between (i) 3 millimeter (length) and 3 millimeter (width) and (ii) 9 millimeter (length) and 9 millimeter (width). The mesh material is made of one comprised of one from the group consisting of a plastic mesh and a fabric mesh. In an embodiment, the openings in the mesh material are substantially uniform. In a further embodiment, the openings in the mesh material are non-uniform, the openings being one size for use on a predetermined portion of the covered object and the openings being a different size for use on a different predetermined portion of the covered object.

The layers may be coupled or adhered using an adhesive, such as one selected from the group consisting of a pressure-sensitive adhesive, a contact adhesive and a hot adhesive or may be laminated. Adhesives for coupling the layers of the backing to the reflective radiant barrier and in some embodiments the mesh material to the reflective radiant barrier includes pressure-sensitive adhesives, contact adhesives or hot adhesives. An adhesive is any substance applied to the surfaces of the layered material that binds them together and resists separation. The term “adhesive” may be used interchangeably with glue, laminate, cement, mucilage, or paste.

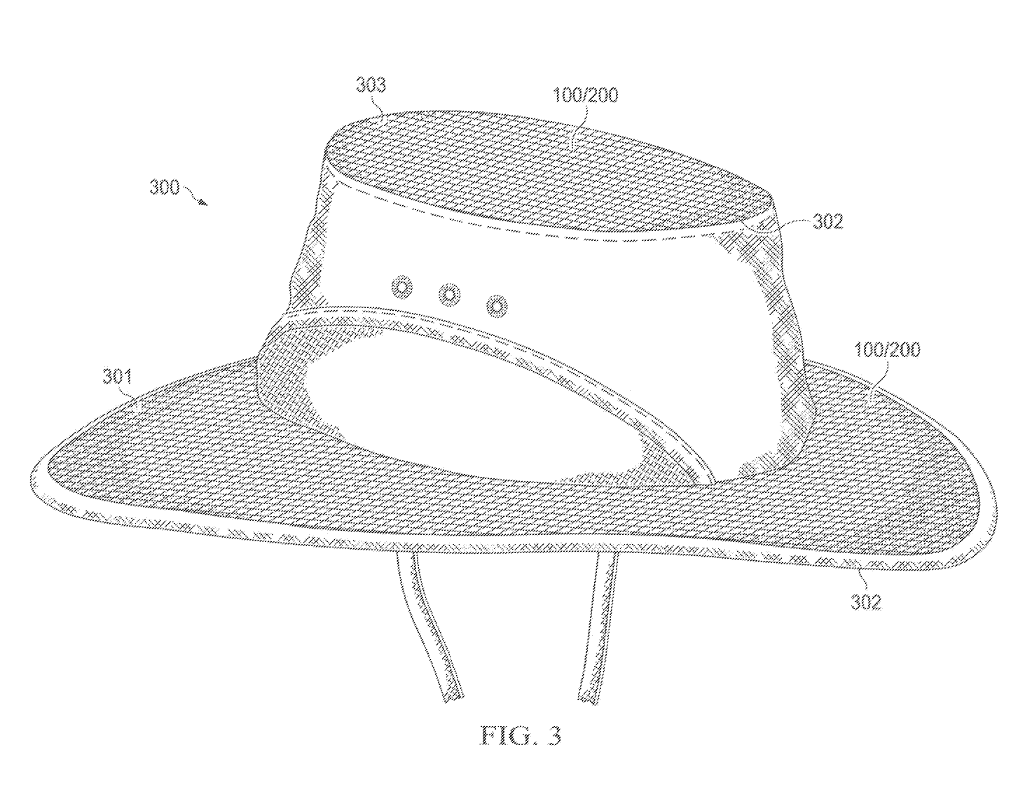

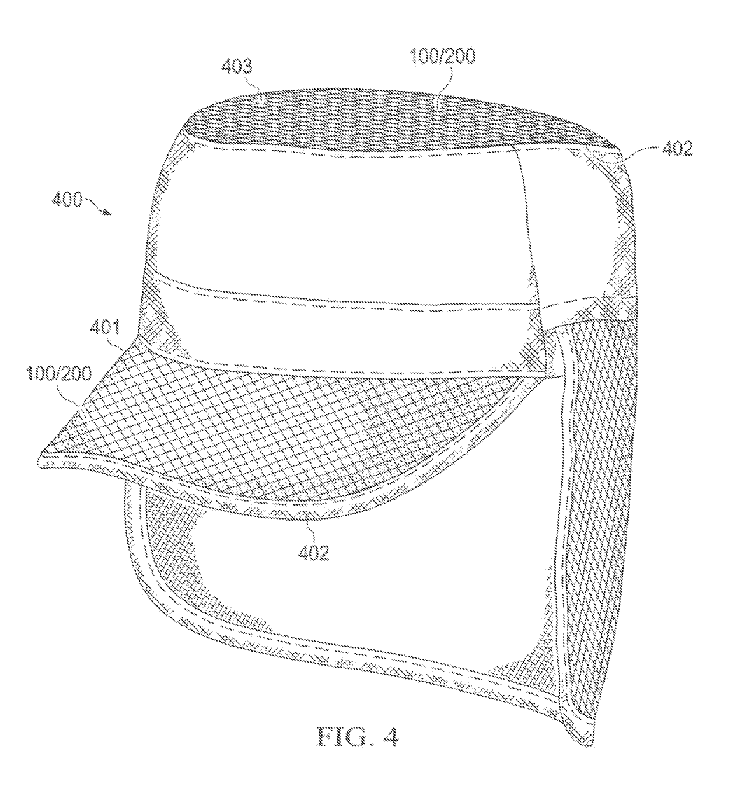

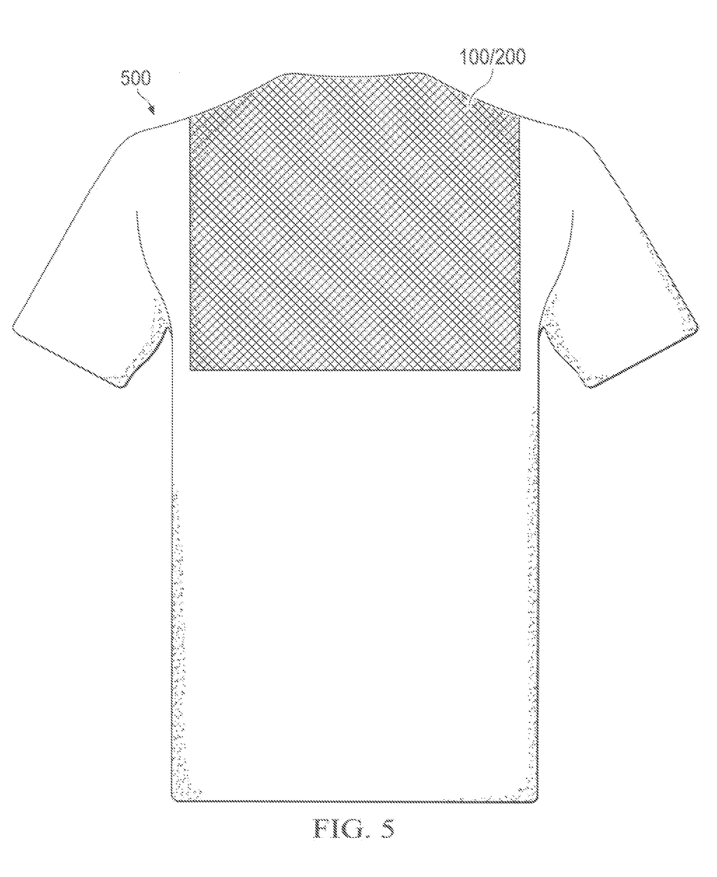

In an embodiment, as seen in FIG. 3, the mesh material is sewn to a periphery 302 of an external portion of an object on which the layered material 100 is disposed, such as a river hat brim 301 or river hat top 303. Similarly, in an embodiment seen in FIG. 4, the mesh material is sewn to a periphery 402 of an external portion of an object on which the layered material 100 is disposed, such as a desert hat brim 401 or desert hat top 403.

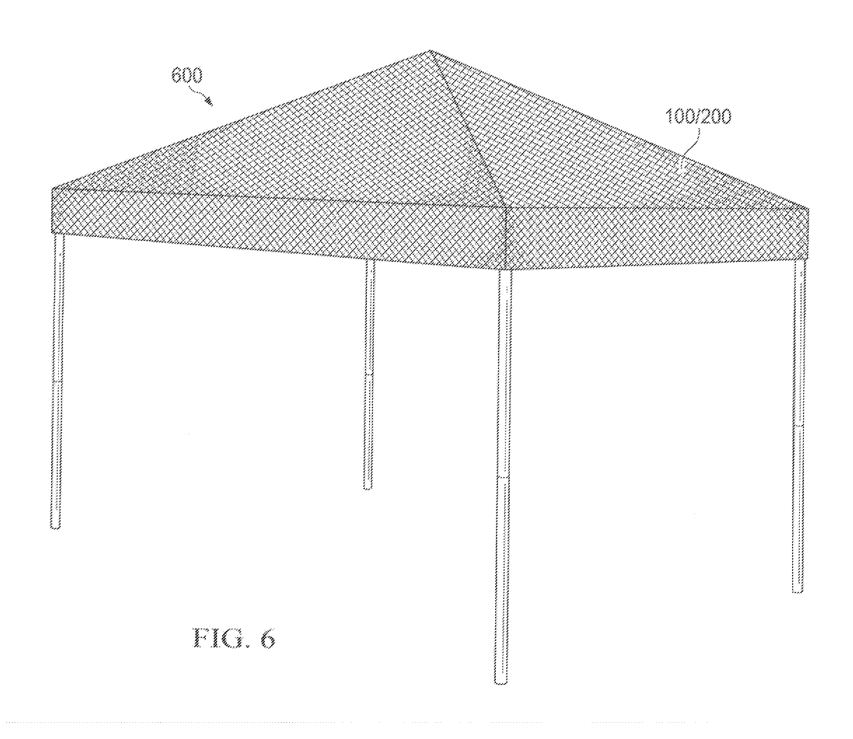

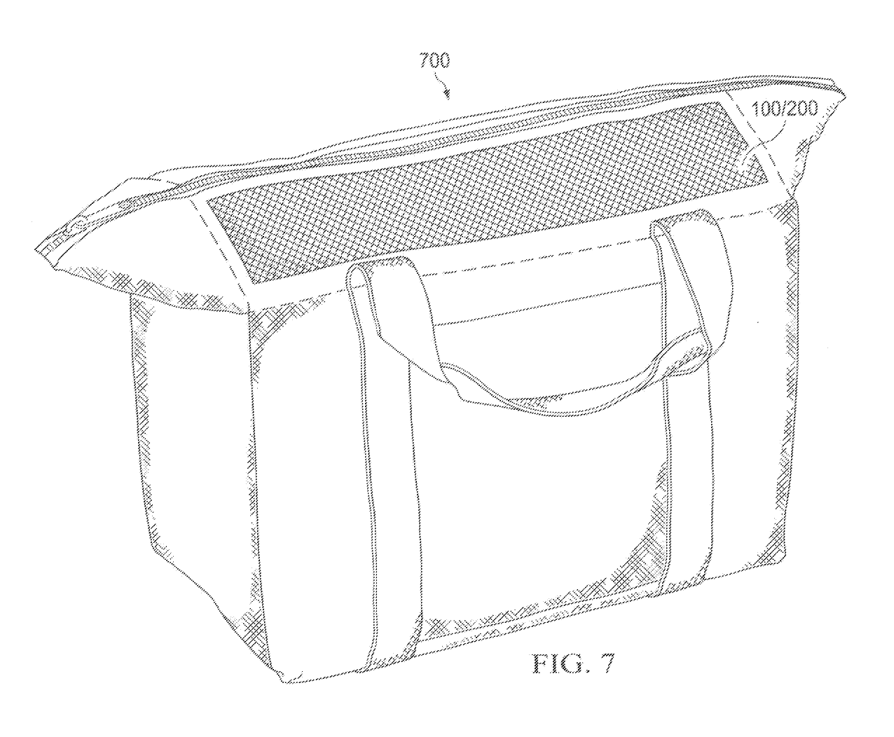

As seen in FIGS. 3-7, the layered material 100 or 200 can be disposed on a hat 300, 400 a shirt 500, a shade structure canopy 600 or a soft sided cooler 700. Further products to which the invention can be disposed include, but are not limited to, headwear, apparel such as jackets, pants, scarves, shirts, hats, gloves, mittens, and the like, footwear such as shoes, boots, slippers, and the like. Further inventions include tents, umbrellas, shades, tent fly's, windshield sun shades, baby carriage canopies and blankets.

As seen in FIGS. 3 and 4, the layered material 100 is shown on different areas of a river hat and a desert hat. The invention further comprises a resilient radiant barrier for use with objects such as hats, clothing, duffle bags and soft-sided coolers. The resilient radiant barrier includes a planar backing material having a back surface and a front surface, a planar radiant barrier material having a back surface and a front surface, the front surface of the planar radiant barrier comprising a reflective radiant surface, the back surface of the planar radiant barrier material being adhered to the front surface of the planar backing; and a mesh material having a plurality of substantially uniform openings, the mesh material disposed on the front surface of the planar radiant barrier material and sewn to a periphery of an object on which the resilient radiant barrier is disposed.

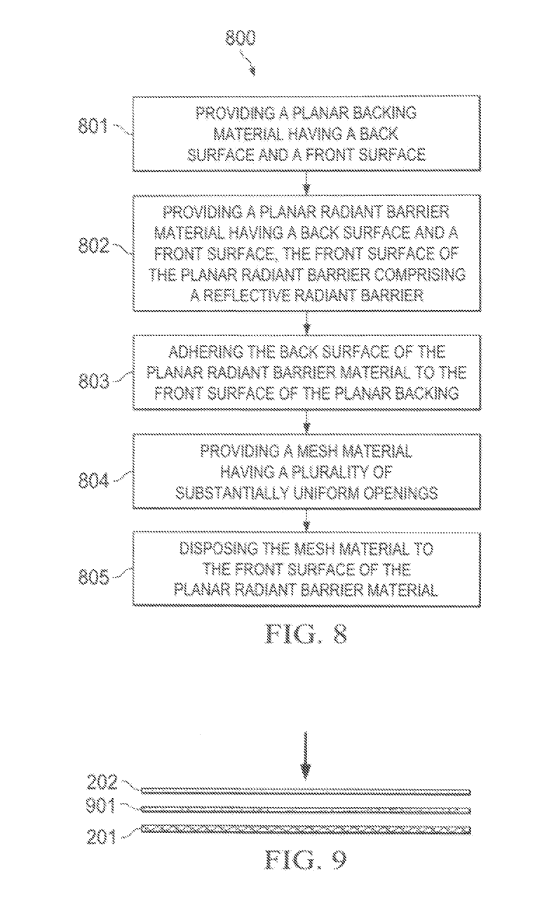

As seen in FIG. 8, the invention further comprises a method 800 of making a resilient radiant reflective barrier, comprising the steps of: providing a planar backing material having a back surface and a front surface 801, providing a planar radiant barrier material having a back surface and a front surface 802, the front surface of the planar radiant barrier comprising a reflective radiant barrier, adhering the back surface of the planar radiant barrier material to the front surface of the planar backing, providing a mesh material having a plurality of substantially uniform openings 804, and disposing the mesh material to the front surface of the planar radiant barrier material 805. FIG. 9 is a side view of two layers, 201, 202, of the three layers of the invention with a glue layer 901 thereinbetween.

The invention further comprises a resilient radiant barrier for use with objects such as hats, clothing, duffle bags and soft-sided coolers comprised of a planar, laminated reflective barrier material having a back surface and a front surface; and a mesh material having a plurality of substantially uniform openings, the mesh material disposed on the front surface of the planar radiant barrier material and sewn to a periphery of an object on which the resilient radiant barrier is disposed.

The invention further allows for the effective utilization of radiant barrier technology in soft (sewn) goods applications that can reflect radiant heat (infrared waves) and block skin harmful UV rays while maintaining the soft, “hand feel” of apparel; at the same time protecting the radiant barrier from accidental damage. The invention provides high performance sun protection for outdoor enthusiasts in a wide variety of soft goods applications.

While the present invention has been described by reference to certain embodiments, it is pointed out that the embodiments described are illustrative rather than limiting in nature and that many variations and modifications are possible within the scope of the present invention. For example, the mesh openings and thickness, the radiant barrier thickness and backing fabric can comprise a variety of sizes. Many such variations and modifications may be considered obvious and desirable by those skilled in the art based upon a review of the foregoing description of preferred embodiments. For example, the invention utilizes a solid radiant barrier film to maximize heat reflective and UV blocking performance in a soft apparel like material which can be perforated for breathability if required for the specific application. The radiant barrier material is protected from damage by an open mesh that still allows direct exposure to the radiant heat source.

What is claimed is:

1. A layered material, comprising:
a planar backing material having a back surface and a front surface;
a planar radiant barrier material having a back surface and a front surface, the front surface of the planar radiant barrier material comprising a reflective radiant surface, the back surface of the planar radiant barrier material being coupled to the front surface of the planar backing material; and
a mesh material having a plurality of substantially uniform openings, the mesh material disposed on the front surface of the planar radiant barrier material.

2. The layered material of claim 1 wherein the planar backing material comprises a laminated material.

3. The layered material of claim 1 wherein the planar backing material comprises a textile or fabric material.

4. The layered material of claim 1 wherein the planar backing material comprises a cardboard material.

5. The layered material of claim 1, wherein the planar backing material is between 0.3 mm and 0.10 mm thick.

6. The layered material of claim 1, wherein the planar radiant barrier material comprises one selected from the group consisting of a metallized polyester, an aluminized cloth, a metallized film and a polymer film coated with a thin layer of aluminum.

7. The layered material of claim 1, wherein the planar radiant barrier material is between 0.05 mm and 0.25 mm thick.

8. The layered material of claim 1, wherein the size of the openings in the mesh material is optimized to provide resiliency to the layered material while providing sufficient opening size to allowing maximum reflectance, the openings either being uniform or non-uniform across a covered object.

9. The layered material of claim 8, wherein the mesh material openings are between the sizes of 3 millimeter radius and 9 millimeter radius.

10. The layered material of claim 8, wherein the mesh material openings are between (i) 3 millimeter (length) and 3 millimeter (width) and (ii) 9 millimeter (length) and 9 millimeter (width).

11. The layered material of claim 1 wherein the mesh material is made of one comprised of one from the group consisting of a plastic mesh and a fabric mesh.

12. The layered material of claim 1, wherein the layers are coupled using one selected from the group consisting of a pressure-sensitive adhesive, a contact adhesive and a hot adhesive.

13. The layered material of claim 1 wherein the mesh material is sewn to a periphery of an external portion of an object on which the layered material is disposed.

14. The layered material of claim 1, wherein the layered material is disposed on a hat.

15. The layered material of claim 1, wherein the layered material is disposed on a shirt.

16. The layered material of claim 1, wherein the layered material is disposed on a shade structure.

17. The layered material of claim 1, wherein the layered material is disposed on a soft sided cooler.

18. A resilient radiant barrier for use with objects such as hats, clothing, duffle bags, shade structures and soft-sided coolers, comprising:
a planar, laminated reflective barrier material having a back surface and a front surface; and
a mesh material having a plurality of openings, the mesh material disposed on the front surface of the planar radiant barrier material and sewn to a periphery of an object on which the resilient radiant barrier is disposed.

19. The resilient radiant barrier of claim 18, disposed on an object consisting of one of a hat, article of clothing, duffle bag and soft-sided cooler.

20. A method of making a resilient radiant reflective barrier, comprising the steps of:
providing a planar backing material having a back surface and a front surface;
providing a planar radiant barrier material having a back surface and a front surface, the front surface of the planar radiant barrier comprising a reflective radiant barrier;
adhering the back surface of the planar radiant barrier material to the front surface of the planar backing;
providing a mesh material having a plurality of substantially uniform openings; and
disposing the mesh material to the front surface of the planar radiant barrier material.
